(19) United States
(12) Patent Application Publication
(10) Pub. No.: US 2026/0135295 A1
(43) Pub. Date: May 14, 2026

(54) INTEGRATED ANTENNA DEVICE AND PHASE CALIBRATION METHOD THEREOF

(71) Applicant: TMY Technology Inc., New Taipei City (TW)

(72) Inventors: Su-Wei Chang, New Taipei City (TW); Chih-Hsien Wu, New Taipei City (TW); Chun-Cheng Chan, New Taipei City (TW); Hsuan-Hung Kuo, New Taipei City (TW); Xian Wu Lin, New Taipei City (TW)

(73) Assignee: TMY Technology Inc., New Taipei City (TW)

(21) Appl. No.: 19/329,495

(22) Filed: Sep. 15, 2025

(30) Foreign Application Priority Data
Nov. 12, 2024 (CN) 202411613077.6

(51) Int. Cl. H01Q 3/36

(52) U.S. Cl. CPC H01Q 3/36

(57) ABSTRACT

An integrated antenna device and a phase calibration method thereof are provided. The integrated antenna device includes an antenna array formed by patch antenna units and a beamforming integrated circuit. The antenna array is disposed on a first surface of a substrate. The patch antenna units are symmetrically arranged around an array center of the antenna array, and each of the patch antenna units includes a first feed point and a second feed point. The BFIC is disposed on a second surface of the substrate and connected to the first feed point and the second feed point of each patch antenna unit. The first feed point and the second feed point of each patch antenna unit are disposed outside each patch antenna unit relative to the array center of the antenna array. The BFIC overlaps a central area of the antenna array.

### CROSS-REFERENCE TO RELATED APPLICATION

This application claims the priority benefit of China application serial no. 202411613077.6, filed on Nov. 12, 2024. The entirety of the above-mentioned patent application is hereby incorporated by reference herein and made a part of this specification.

### BACKGROUND

### Technical Field

The disclosure relates to an integrated antenna device and a phase calibration method thereof.

### Description of Related Art

Millimeter waves generally refer to electromagnetic waves with wavelengths between 1 millimeter and 10 millimeters, corresponding to a frequency range of approximately 30 GHz to 300 GHz. Since millimeter waves have higher frequencies, they may provide wider bandwidths, thereby supporting higher data transmission rates. Millimeter wave technology has been gradually and widely applied, significantly improving network capacity and speed. However, due to the shorter wavelengths of millimeter waves, they are easily blocked and attenuated by obstacles during propagation, resulting in smaller coverage areas. To address this issue, beamforming technology has been introduced.

Beamforming is a technology that controls the signal transmission direction by adjusting the phase and amplitude of each patch antenna unit in an antenna array. Beamforming may concentrate signal energy in a specific direction, thereby enhancing signal strength, reducing interference, and improving the reliability and efficiency of wireless communication. Antenna arrays that implement beamforming generally include a large number of patch antenna units. The failure of any patch antenna unit or other passive component may affect the beamforming performance of the entire antenna array. If the entire antenna array must be dismantled for repair due to the failure of a single patch antenna unit, the maintenance time and cost are highly uneconomical. Additionally, the estimation and correction of phase errors among a large number of patch antenna units are complex and challenging.

### SUMMARY

The disclosure provides an integrated antenna device and a phase calibration method thereof, which may be used to address the aforementioned technical problems.

In an embodiment of the disclosure, the integrated antenna device includes an antenna array formed by multiple patch antenna units and a beamforming integrated circuit. The antenna array is disposed on a first surface of a substrate. The patch antenna units are symmetrically arranged around an array center of the antenna array, and each of the patch antenna units includes a first feed point and a second feed point. The beamforming integrated circuit is disposed on a second surface of the substrate opposite to the first surface and connected to the first feed point and the second feed point of each of the patch antenna units. Each of the patch antenna units includes a first linear radiation portion having a first polarization direction and a second linear radiation portion having a second polarization direction. The first linear radiation portion includes the first feed point, and the second linear radiation portion includes the second feed point.

An extending direction of the first linear radiation portion is perpendicular to an extending direction of the second linear radiation portion. The first feed point and the second feed point of each of the patch antenna units are disposed outside each of the patch antenna units relative to the array center of the antenna array, and the beamforming integrated circuit overlaps a central area of the antenna array.

In another embodiment of the disclosure, the antenna array of the integrated antenna device includes a first patch antenna unit, a second patch antenna unit, a third patch antenna unit, and a fourth patch antenna unit arranged in a 2×2 matrix. The phase calibration method of the integrated antenna device includes the following steps. A first radio frequency signal from a far field is received through the first patch antenna unit and the second patch antenna unit. Multiple radio frequency signals respectively generated in response to the first radio frequency signal by the first patch antenna unit and the second patch antenna unit are mixed to produce a first mixed signal. A second radio frequency signal is transmitted to the far field through the first patch antenna unit and the second patch antenna unit. Multiple radio frequency signals generated in response to the second radio frequency signal by the first patch antenna unit and the second patch antenna unit are mixed to produce a second mixed signal. A first phase error between the first patch antenna unit and the second patch antenna unit is determined according to an amplitude ratio of the first mixed signal and the second mixed signal.

To make the features and advantages of the disclosure more comprehensible, several embodiments accompanied with drawings are described in detail as follows.

### BRIEF DESCRIPTION OF THE DRAWINGS

FIG. 1 is a block schematic diagram of an integrated antenna device according to an embodiment of the disclosure.

FIGS. 2A and 2B are perspective schematic diagrams of an integrated antenna device from different views according to an embodiment of the disclosure.

FIG. 3A is a schematic diagram of multiple patch antenna units and feed points according to an embodiment of the disclosure.

FIG. 3B is a schematic diagram of multiple patch antenna units and feed points according to an embodiment of the disclosure.

FIG. 3C is a schematic diagram of multiple patch antenna units and feed points according to an embodiment of the disclosure.

FIG. 4 is a flowchart of a phase calibration method for an integrated antenna device according to an embodiment of the disclosure.

FIG. 5 is a schematic diagram of the radiation field pattern of multiple patch antenna units according to an embodiment of the disclosure.

### DESCRIPTION OF THE EMBODIMENTS

The directional terms mentioned herein, such as “upper,” “lower,” “front,” “rear,” “left,” “right,” and the like, are merely references to the directions shown in the drawings. Therefore, the directional terms are used for explanation and not for limiting the disclosure.

In the drawings, the figures illustrate general features of methods, structures, or materials used in specific embodiments. However, these figures should not be construed as defining or limiting the scope or nature encompassed by these embodiments. For example, for clarity, the relative sizes, thicknesses, and positions of various layers, regions, or structures may be reduced or enlarged.

In the following embodiments, the same or similar elements will be denoted by the same or similar reference numerals, and redundant descriptions will be omitted. Additionally, features of different embodiments may be combined with one another as long as no conflicts arise. Simple equivalent changes and modifications based on this specification or the claims of the patent are still within the scope covered by this patent.

The terms “first,” “second,” and the like mentioned in this specification or the claims of the patent are only used to name different elements or distinguish between different embodiments or scopes, and are not intended to limit the upper or lower limits of the number of elements, nor to define the manufacturing order or arrangement sequence of the elements. Furthermore, an element/layer disposed on (or above) another element/layer may encompass cases where the element/layer is directly disposed on (or above) the other element/layer, and the two elements/layers are in direct contact; as well as cases where the element/layer is indirectly disposed on (or above) the other element/layer, with one or more elements/layers present between the two elements/layers.

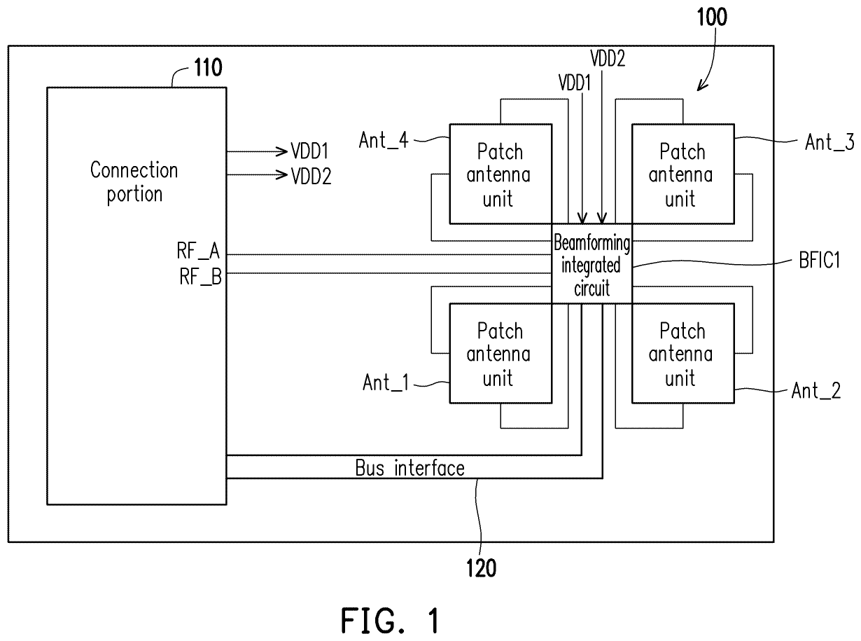

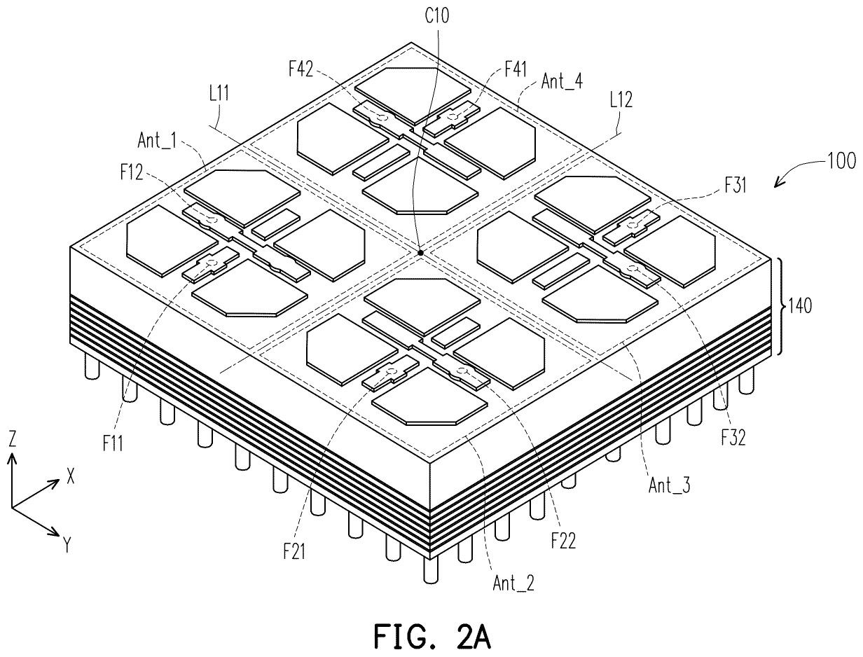

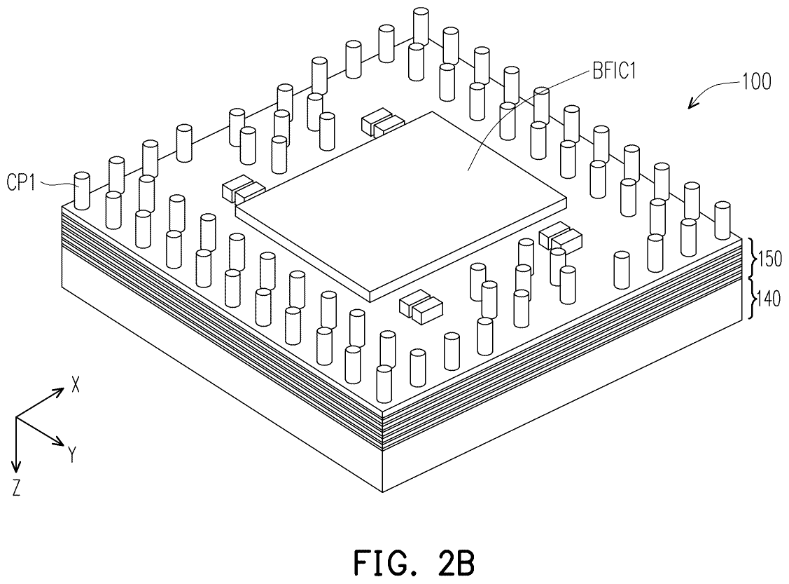

FIG. 1 is a block schematic diagram of an integrated antenna device according to an embodiment of the disclosure. FIGS. 2A and 2B are perspective schematic diagrams of an integrated antenna device from different views according to an embodiment of the disclosure. Please refer to FIG. 1, FIG. 2A, and FIG. 2B together.

In some embodiments, an integrated antenna device 100 includes an antenna array formed by multiple patch antenna units Ant_1, Ant_2, Ant_3, and Ant_4, and a beamforming integrated circuit BFIC1. According to some embodiments, the patch antenna units Ant_1, Ant_2, Ant_3, and Ant_4 of the integrated antenna device 100 may radiate radio frequency (RF) signals into the surrounding environment. According to some embodiments, the patch antenna units Ant_1, Ant_2, Ant_3, and Ant_4 of the integrated antenna device 100 may receive RF signals from the surrounding environment.

In some embodiments, the integrated antenna device 100 includes a substrate 140. The antenna array is disposed on a first surface of the substrate 140. In other words, the patch antenna units Ant_1 to Ant_4 are disposed on the first surface of the substrate 140. In some embodiments, the patch antenna units Ant_1 to Ant_4 may be multiple metallic patches printed on the substrate 140. The antenna patterns of the patch antenna units Ant_1 to Ant_4 are identical. As shown in FIG. 2A, the patch antenna units Ant_1 to Ant_4 are symmetrically arranged around an array center C10 of the antenna arrays. The patch antenna units Ant_1 to Ant_4 are symmetrically disposed relative to a first axis L11 and a second axis L12. The first axis L11 and the second axis L12 are perpendicular to each other. The first axis L11 and the second axis L12 intersect at an array center C10 of the antenna arrays. In some embodiments, the patch antenna units Ant_1 to Ant_4 may be distributed equidistantly at the four corners of the substrate 140. Additionally, the substrate 140 may include an insulating dielectric layer, and the dielectric material of the insulating dielectric layer may be ceramic, polytetrafluoroethylene, or other insulating materials.

In some embodiments, the patch antenna units Ant_1 to Ant_4 are arranged in a 2×2 matrix. The distance between any two adjacent patch antenna units among Ant_1 to Ant_4 is half the wavelength corresponding to the center frequency of the operational frequency band of the antenna array in the operational environment. For example, assuming the center frequency of the operational frequency band of the antenna array is 30 GHz, and the antenna array operates in a vacuum or air, half the wavelength corresponding to the center frequency in this operational environment (which in this case is also the vacuum wavelength) is approximately 0.5 cm. In other words, assuming the center frequency of the operational frequency band of the antenna array is 30 GHz, the distance from the geometric center of the patch antenna unit Ant_1 to the geometric center of the patch antenna unit Ant_4 may be 0.5 cm. Additionally, the distance from the geometric center of the patch antenna unit Ant_1 to the geometric center of the patch antenna unit Ant_2 may likewise be 0.5 cm.

In some embodiments, each of the patch antenna units Ant_1 to Ant_4 may be a dual-polarized antenna, and therefore each patch antenna unit Ant_1 to Ant_4 may include two feed points. Specifically, the patch antenna unit Ant_1 may include a first feed point F11 and a second feed point F12. The patch antenna unit Ant_2 may include a first feed point F21 and a second feed point F22. The patch antenna unit Ant_3 may include a first feed point F31 and a second feed point F32. The patch antenna unit Ant_4 may include a first feed point F41 and a second feed point F42. These feed points are used to transfer RF signals from transmission lines to the patch antenna units Ant_1 to Ant_4, or to transfer received electromagnetic wave signals from the patch antenna units Ant_1 to Ant_4 back to the transmission lines.

In some embodiments, each of the patch antenna units Ant_1 to Ant_4 has a first polarization direction and a second polarization direction orthogonal to the first polarization direction. The first polarization direction may be a vertical polarization direction, and the second polarization direction may be a horizontal polarization direction. The first feed points F11, F21, F31, and F41 are configured to enable each of the patch antenna units Ant_1 to Ant_4 to transmit and receive according to the first polarization direction. The second feed points F12, F22, F32, and F42 are configured to enable each of the patch antenna units Ant_1 to Ant_4 to transmit and receive according to the second polarization direction. In other words, in some embodiments, the first feed points F11, F21, F31, and F41 are configured to transmit and receive RF signals in the vertical polarization direction, and the second feed points F12, F22, F32, and F42 are configured to transmit and receive RF signals in the horizontal polarization direction. Accordingly, the patch antenna units Ant_1 to Ant_4 may emit RF signals in any linear polarization, as well as elliptical or circular polarizations.

In some embodiments, each of the patch antenna units Ant_1 to Ant_4 may include a first linear radiation portion having a first polarization direction and a second linear radiation portion having a second polarization direction. The first linear radiation portions of the patch antenna units Ant_1 to Ant_4 respectively include the first feed points F11, F21, F31, and F41, and the second linear radiation portions of the patch antenna units Ant_1 to Ant_4 respectively include the second feed points F12, F22, F32, and F42. The extending direction of the first linear radiation portion is perpendicular to the extending direction of the second linear radiation portion.

In some embodiments, the substrate 140 may include a printed circuit board (PCB) with a stacked structure. The printed circuit board may include multiple insulating layers and multiple conductive layers. The conductive layers of the printed circuit board may be configured to include different circuit patterns.

In some embodiments, the beamforming integrated circuit BFIC1 is disposed on a surface of the substrate 140. The beamforming integrated circuit BFIC1 is disposed on a second surface of the substrate 140 opposite to the first surface. The beamforming integrated circuit BFIC1 may control the signal phases and amplitudes of the patch antenna units Ant_1 to Ant_4, thereby focusing transmitted and received signals in specific directions to achieve beamforming functionality. The beamforming integrated circuit BFIC1 may include multiple phase shifters and multiple power amplifiers. In some embodiments, the beamforming integrated circuit BFIC1 may be connected to the substrate 140 via conductive bumps, such as ball grid array (BGA) bumps, though not limited thereto.

In some embodiments, a conductive layer of the substrate 140 may include grounding patches configured as a grounding layer. The grounding layer in the substrate 140 is configured to provide grounding levels to the beamforming integrated circuit BFIC1 and the patch antenna units Ant_1 to Ant_4.

In some embodiments, the integrated antenna device 100 may further include surface-mounted components disposed on a surface of the substrate 140, such as resistors, capacitors, inductors, power amplifier ICs, or other passive components. The surface-mounted components may be connected to the beamforming integrated circuit BFIC1 through conductive layers of the substrate 140.

In some embodiments, the beamforming integrated circuit BFIC1 is connected to the first feed points F11, F21, F31, and F41 and the second feed points F12, F22, F32, and F42 of the patch antenna units Ant_1 to Ant_4. Furthermore, the substrate 140 may include conductive through vias, and the beamforming integrated circuit BFIC1 may be electrically connected to the first feed points F11, F21, F31, and F41 and the second feed points F12, F22, F32, and F42 of the patch antenna units Ant_1 to Ant_4 through these conductive through vias and conductive traces of the substrate 140's conductive layers.

In some embodiments, the positions of the first feed points F11, F21, F31, and F41 are symmetrically distributed relative to the first axis L11 and the second axis L12, and the positions of the second feed points F12, F22, F32, and F42 are symmetrically distributed relative to the first axis L11 and the second axis L12.

In some embodiments, the radio frequency signal transmission paths between the patch antenna units Ant_1 to Ant_4 and the beamforming integrated circuit BFIC1 are substantially identical in length. The electrical lengths of the radio frequency signal transmission paths between the patch antenna units Ant_1 to Ant_4 and the beamforming integrated circuit BFIC1 are substantially equal. In other words, the radio frequency signal transmission paths between the first feed points F11, F21, F31, and F41 of the patch antenna units Ant_1 to Ant_4 and the beamforming integrated circuit BFIC1 are substantially equal in length. The radio frequency signal transmission paths between the second feed points F12, F22, F32, and F42 of the patch antenna units Ant_1 to Ant_4 and the beamforming integrated circuit BFIC1 are also substantially equal in length. The radio frequency signal transmission paths between the patch antenna units Ant_1 to Ant_4 and the beamforming integrated circuit BFIC1 are reciprocal.

In some embodiments, the first feed points F11, F21, F31, and F41 and the second feed points F12, F22, F32, and F42 of the patch antenna units Ant_1 to Ant_4 are disposed outside each of the patch antenna units Ant_1 to Ant_4 relative to the array center C10 of the antenna arrays. Furthermore, the beamforming integrated circuit BFIC1 overlaps the central area of the antenna arrays. In some embodiments, the center point of the central area of the antenna arrays is the array center C10 of the antenna arrays.

In some embodiments, the center of the beamforming integrated circuit BFIC1 is projected along the normal direction of the surface of the substrate 140 (i.e., the Z-axis direction) onto the array center C10 of the antenna arrays. In other words, the orthogonal projection of the beamforming integrated circuit BFIC1 on the first surface of the substrate 140 is located in the central area of the antenna arrays.

As a result, because the first feed points F11, F21, F31, and F41 and the second feed points F12, F22, F32, and F42 of the patch antenna units Ant_1 to Ant_4 are positioned farther away from the array center C10, the radio frequency signal transmission paths between the first feed points F11, F21, F31, and F41 and the second feed points F12, F22, F32, and F42 of the patch antenna units Ant_1 to Ant_4 and the beamforming integrated circuit BFIC1 may be extended. Therefore, the radio frequency signal transmission paths between the beamforming integrated circuit BFIC1 and the patch antenna units Ant_1 to Ant_4 may be distributed more widely. When the radio frequency signal transmission paths between the beamforming integrated circuit BFIC1 and the patch antenna units Ant_1 to Ant_4 are more widely distributed, signal interference among the radio frequency signal transmission paths may be reduced. Moreover, the difficulty and space constraints for arranging surface-mounted components on the surface of the substrate 140 may also be reduced.

In some embodiments, the integrated antenna device 100 further includes a connection portion 110. The integrated antenna device 100 may communicate with external devices and transmit electrical signals via the connection portion 110. In some embodiments, the connection portion 110 may include multiple copper pillars disposed on the substrate 140, such as a copper pillar CP1 shown in FIG. 2B.

In some embodiments, the connection portion 110 may be configured to receive external power VDD1 and VDD2, allowing the beamforming integrated circuit BFIC1 to receive external power VDD1 and VDD2 through the connection portion 110. Additionally, the connection portion 110 may be configured to connect to the beamforming integrated circuit BFIC1 via a bus interface 120. Furthermore, the beamforming integrated circuit BFIC1 may have a bus port and may receive external control data through the bus port and the connection portion 110. The bus interface 120 may be, for example, a serial peripheral interface bus (SPI). The connection portion 110 may also be configured to transmit radio frequency signals to and from the beamforming integrated circuit BFIC1. Furthermore, the common port of the beamforming integrated circuit BFIC1 may receive externally provided radio frequency signals RF_A and RF_B from the connection portion 110.

In some embodiments, the first linear radiation portion of each of the patch antenna units Ant_1 to Ant_4 includes the first feed points F11, F21, F31, and F41, and the second linear radiation portion of each of the patch antenna units Ant_1 to Ant_4 includes the second feed points F12, F22, F32, and F42. Additionally, each of the patch antenna units Ant_1 to Ant_4 further includes multiple radiation portions, which are cloverleaf-shaped structures.

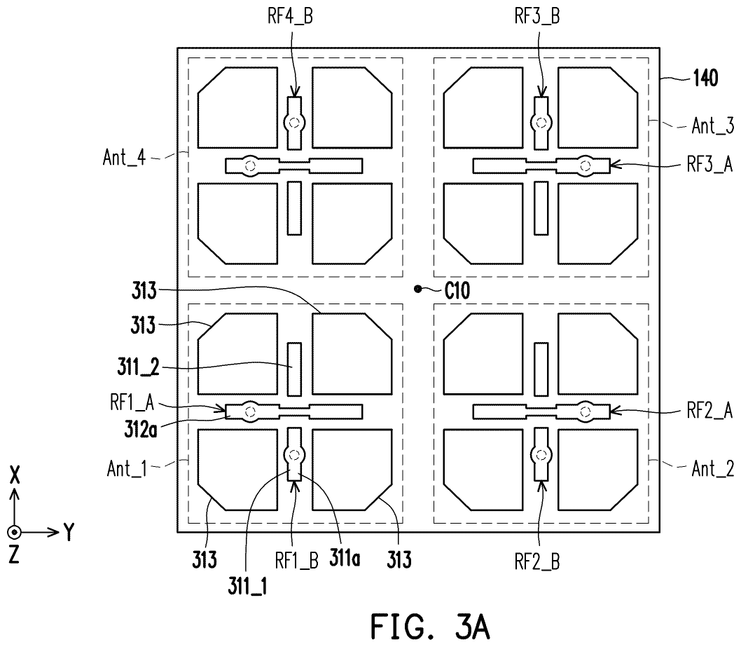

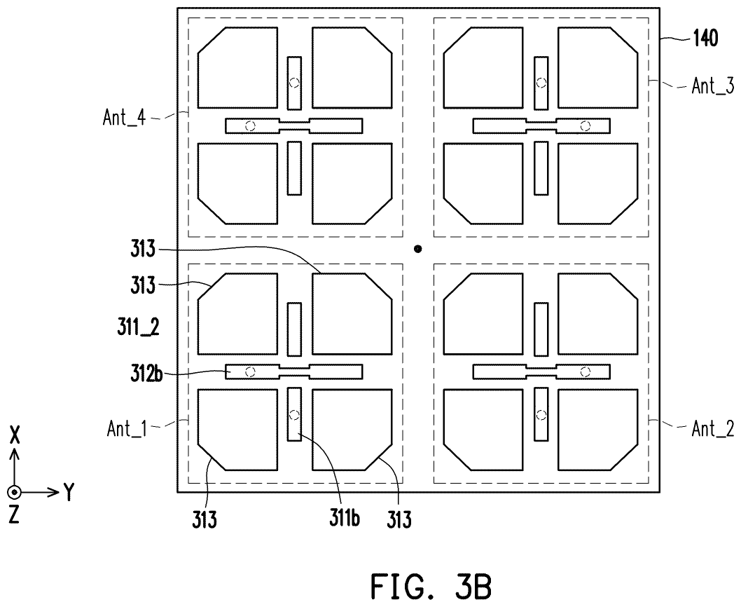

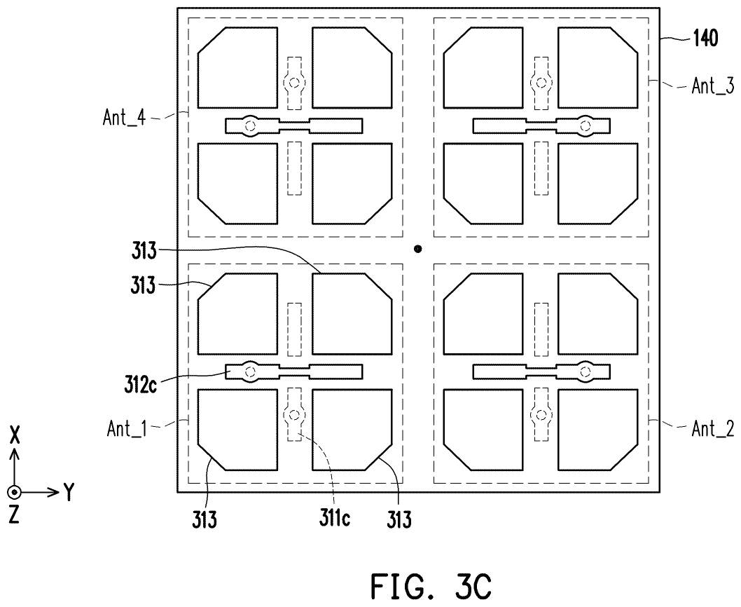

FIGS. 3A to 3C are schematic diagrams of multiple patch antenna units and feed points according to an embodiment of the disclosure. Referring to FIG. 3A, in some embodiments, the patch antenna unit Ant_1 may include a first linear radiation portion 311a, a second linear radiation portion 312a, and multiple field pattern adjustment portions 313. The first linear radiation portion 311a extends along the X-axis direction, while the second linear radiation portion 312a extends along the Y-axis direction. The multiple field pattern adjustment portions 313 are cloverleaf-shaped structures. In other words, the multiple field pattern adjustment portions 313 form a cross-symmetrical structure, with the cloverleaf-shaped structures being symmetrically arranged in the center as rectangular, sector-shaped, or wedge-shaped radiators. The multiple field pattern adjustment portions 313 may be used to adjust the field pattern and increase the bandwidth. The first linear radiation portion 311a and the second linear radiation portion 312a are disposed within the cross-shaped gaps formed by the multiple field pattern adjustment portions 313. The first linear radiation portion 311a may transmit and receive radio frequency signals corresponding to the first polarization direction through the first feed point F11. The second linear radiation portion 312a may transmit and receive radio frequency signals corresponding to the second polarization direction through the second feed point F12.

In the example of FIG. 3A, the width of the metallic microstrip of the first linear radiation portions of the antenna units Ant_1 to Ant_4 may be partially widened at the feed points. Similarly, the width of the metallic microstrip of the second linear radiation portions of the antenna units Ant_1 to Ant_4 may be partially widened at the feed points.

It should be noted that, in some embodiments, the first linear radiation portion 311a includes a first sub-radiator 311_1 and a second sub-radiator 311_2. There is a gap between the first sub-radiator 311_1 and the second sub-radiator 311_2, and the first linear radiation portion 311a extends through the gap between the first sub-radiator 311_1 and the second sub-radiator 311_2. The first feed point F11 and the second feed point F12 of the patch antenna unit Ant_1 are disposed outside the patch antenna unit Ant_1 relative to the array center C10 of the antenna arrays. Specifically, the first feed point F11 is disposed on the first sub-radiator 311_1, which is farther from the array center C10. The second linear radiation portion 312a has two ends, and the second feed point F12 is disposed on the end of the second linear radiation portion 312a that is farther from the array center C10.

Similarly, the patch antenna units Ant_2 to Ant_4 may respectively receive radio frequency signals corresponding to the first polarization direction. The patch antenna units Ant_2 to Ant_4 may respectively receive radio frequency signals corresponding to the second polarization direction.

However, for the sake of clarity and ease of illustration, FIG. 3A uses the patch antenna unit Ant_1 as an example to illustrate the antenna pattern. It is evident that the antenna patterns of the patch antenna units Ant_1 to Ant_4 are identical, and therefore the antenna patterns of the other patch antenna units Ant_2 to Ant_4 may be easily inferred from the above description, which will not be redundantly detailed here.

It must be particularly noted that, due to various factors such as manufacturing tolerances and position differences of the antenna units, there are phase errors among the patch antenna units Ant_1 to Ant_4. However, the phase errors among the patch antenna units Ant_1 to Ant_4 have an adverse impact on beamforming. For instance, unexpected phase errors among the patch antenna units Ant_1 to Ant_4 may result in the main lobe direction of the beam deviating or the beam width changing, thereby causing beam distortion. In the embodiments of the disclosure, the integrated antenna device 100 may efficiently estimate the phase errors among the patch antenna units Ant_1 to Ant_4 through simple calculations and processes, facilitating phase compensation. Examples will be listed below for explanation.

FIG. 3B is a schematic diagram of multiple patch antenna units and feed points according to an embodiment of the disclosure. Referring to FIG. 3B, compared to FIG. 3A, the width of the metallic microstrip of the first linear radiation portions of the antenna units Ant_1 to Ant_4 is not widened based on the feed points. Similarly, the width of the metallic microstrip of the second linear radiation portions of the antenna units Ant_1 to Ant_4 is not widened based on the feed points. For example, the width of the metallic microstrip of a first linear radiation portion 311b and a second linear radiation portion 312b of the antenna unit Ant_1 does not vary due to the feed point configuration.

FIG. 3C is a schematic diagram of multiple patch antenna units and feed points according to an embodiment of the disclosure. Referring to FIG. 3C, compared to FIG. 3A, in some embodiments, a first linear radiation portion 311c corresponding to the first polarization direction is not disposed on the surface of the substrate 140 but is embedded within the substrate 140. In other words, the first linear radiation portion 311c may be disposed on an intermediate layer in the multilayer structure of the substrate 140, while a second linear radiation portion 312c may be disposed on a surface layer of the multilayer structure of the substrate 140.

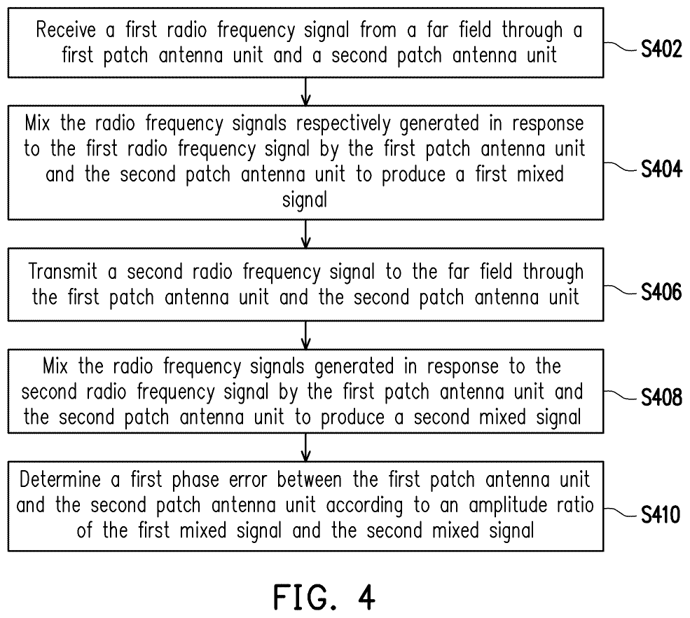

FIG. 4 is a flowchart of a phase calibration method for an integrated antenna device according to an embodiment of the disclosure. For clarity, referring to FIG. 3A and FIG. 4, in step S402, a first radio frequency signal is received from a far field through a first patch antenna unit (in this example, such as the patch antenna unit Ant_1) and a second patch antenna unit (such as the patch antenna unit Ant_4). The first patch antenna unit and the second patch antenna unit are located on the same side of the antenna matrix. Specifically, the first radio frequency signal is transmitted from the far field to the two patch antenna units on the same side to generate information for calculating phase errors.

In some embodiments, the first radio frequency signal may include a first polarized signal having a first polarization direction or a second polarized signal having a second polarization direction. That is, the first polarized signal and the second polarized signal may be transmitted separately from the far field to estimate phase errors corresponding to different polarization directions. The first polarized signal and the second polarized signal may respectively be a vertically polarized signal or a horizontally polarized signal.

In step S404, the radio frequency signals respectively generated in response to the first radio frequency signal by the first patch antenna unit (i.e., the patch antenna unit Ant_1) and the second patch antenna unit (i.e., the patch antenna unit Ant_4) are mixed to produce a first mixed signal.

In some embodiments, when receiving the first radio frequency signal from the far field, the signal feed phase of the first patch antenna unit and the signal feed phase of the second patch antenna unit are configured to differ by 180 degrees, thereby producing a first mixed signal corresponding to destructive interference.

Specifically, when receiving a vertically polarized signal from the first radio frequency signal arriving orthogonally (boresight) to the plane of the antenna array, the signal feed phases of the patch antenna units Ant_1 to Ant_4 may be configured as 0 degrees or 180 degrees, respectively. More specifically, a signal feed phase RF1_B of the patch antenna unit Ant_1 may be configured as 0 degrees. A signal feed phase RF2_B of the patch antenna unit Ant_2 may be configured as 0 degrees. A signal feed phase RF3_B of the patch antenna unit Ant_3 may be configured as 180 degrees. A signal feed phase RF4_B of the patch antenna unit Ant_4 may be configured as 180 degrees. When the signal feed phase of the patch antenna unit Ant_1 and the signal feed phase of the patch antenna unit Ant_4 are configured to differ by 180 degrees, the radio frequency signals respectively generated in response to the first radio frequency signal by the patch antenna units Ant_1 and Ant_4 will undergo constructive interference.

Ideally, when the signal feed phase of the patch antenna unit Ant_1 and the signal feed phase of the patch antenna unit Ant_4 are configured to differ by 180 degrees, the radio frequency signals respectively generated in response to the first radio frequency signal by the patch antenna units Ant_1 and Ant_4 would completely cancel each other out. However, due to the phase error between the patch antenna unit Ant_1 and the patch antenna unit Ant_4, there will be deviations in the destructive interference.

Specifically, the patch antenna unit Ant_1 may generate a radio frequency signal cos wot in response to the first radio frequency signal, and the patch antenna unit Ant_4 may generate a radio frequency signal cos (ωt+π+θ) in response to the first radio frequency signal, where θ represents the phase error between the patch antenna unit Ant_1 and the patch antenna unit Ant_4. Through the computation of the sum and difference product, the first mixed signal may be derived as

$$2 cos ( ω t + \frac{π + θ}{2} ) cos \frac{π + θ}{2} .$$

When θ=0, indicating no phase error between the patch antenna unit Ant_1 and the patch antenna unit Ant_4, the first mixed signal equals 0.

In step S406, a second radio frequency signal is transmitted to the far field through the first patch antenna unit and the second patch antenna unit. Specifically, two patch antenna units located on the same side of the array may transmit the second radio frequency signal to the far field to generate information for calculating the phase error.

In some embodiments, the second radio frequency signal may include a third polarized signal having a first polarization direction or a fourth polarized signal having a second polarization direction. That is, the integrated antenna device 100 may transmit the third polarized signal and the fourth polarized signal separately to calculate the phase errors corresponding to different polarization directions. The third polarized signal and the fourth polarized signal may respectively be vertically polarized signals or horizontally polarized signals.

From another perspective, in some embodiments, the first radio frequency signal received from the far field and the second radio frequency signal transmitted to the far field may both be vertically polarized signals to estimate phase errors for the vertical polarization direction. The first radio frequency signal received from the far field and the second radio frequency signal transmitted to the far field may also both be horizontally polarized signals to estimate phase errors for the horizontal polarization direction.

In step S408, the radio frequency signals generated in response to the second radio frequency signal by the first patch antenna unit (i.e., the patch antenna unit Ant_1) and the second patch antenna unit (i.e., the patch antenna unit Ant_4) are mixed to produce a second mixed signal. Specifically, the far field may receive the two radio frequency signals from the patch antenna units Ant_1 and Ant_4.

In some embodiments, when transmitting the second radio frequency signal to the far field, the signal feed phase of the first patch antenna unit (i.e., the patch antenna unit Ant_1) and the signal feed phase of the second patch antenna unit (i.e., the patch antenna unit Ant_4) are configured to differ by 0 degrees, thereby producing a second mixed signal corresponding to constructive interference.

Specifically, when transmitting the vertically polarized signal of the second radio frequency signal to the far field, the signal feed phases of the patch antenna units Ant_1 to Ant_4 may be configured as 0 degrees or 180 degrees, respectively. More specifically, the signal feed phase RF1_B of the patch antenna unit Ant_1 may be configured as 0 degrees. The signal feed phase RF2_B of the patch antenna unit Ant_2 may be configured as 180 degrees. The signal feed phase RF3_B of the patch antenna unit Ant_3 may be configured as 180 degrees. The signal feed phase RF4_B of the patch antenna unit Ant_4 may be configured as 0 degrees. When the signal feed phase of the patch antenna unit Ant_1 and the signal feed phase of the patch antenna unit Ant_4 are configured to differ by 0 degrees, the radio frequency signals received by the far field from the patch antenna unit Ant_1 and the patch antenna unit Ant_4 will undergo constructive interference. However, due to the phase error between the patch antenna unit Ant_1 and the patch antenna unit Ant_4, there will be deviations in the constructive interference.

Specifically, the patch antenna unit Ant_1 may transmit a radio frequency signal cos ωt, and the patch antenna unit Ant_4 may transmit a radio frequency signal cos (ωt+θ), where θ represents the phase error between the patch antenna unit Ant_1 and the patch antenna unit Ant_4. Through the computation of the sum and difference product, the second mixed signal may be derived as

$$2 cos ( ω t + \frac{θ}{2} ) cos \frac{θ}{2} .$$

When θ=0, indicating no phase error between the patch antenna unit Ant_1 and the patch antenna unit Ant_4, the signal amplitude of the second mixed signal generated in the far field is twice the original signal amplitude.

In step S410, the first phase error between the first patch antenna unit (i.e., the patch antenna unit Ant_1) and the second patch antenna unit (i.e., the patch antenna unit Ant_4) is determined based on the amplitude ratio of the first mixed signal and the second mixed signal.

In some embodiments, the first phase error may be determined based on the amplitude ratio between the first mixed signal and the second mixed signal. In some embodiments, the first phase error is twice the amplitude ratio of the first mixed signal to the second mixed signal. Specifically, the amplitude ratio between the first mixed signal and the second mixed signal is

$$[ 2 cos ( ω t + \frac{π + θ}{2} ) cos \frac{π + θ}{2} ] / [ 2 cos ( ω t + \frac{θ}{2} ) cos \frac{θ}{2} ] = tan \frac{θ}{2} .$$

When θ is sufficiently small, the amplitude ratio approaches θ/2. In other words, since half the phase error approaches the amplitude ratio tan θ/2, the phase error may be calculated as twice the amplitude ratio of the first mixed signal to the second mixed signal.

It is further noted that, based on the assumption that the phase error θ is generally less than step/2 and assuming step is 5.625 degrees (0.098 rad), where step represents the phase adjustment step angle, i.e., the minimum increment for phase adjustment, θ<0.049 rad. Under this condition, the relative error of directly determining the phase error using the amplitude ratio is less than 1/1000. That is, directly determining the phase error using the amplitude ratio is sufficiently accurate.

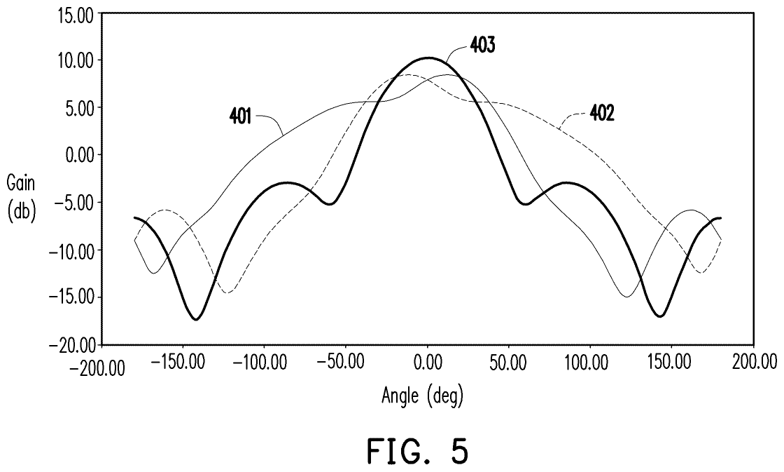

Additionally, FIG. 5 is a schematic diagram of the radiation patterns of multiple patch antenna units according to an embodiment of the disclosure. Referring to FIG. 5, curves 402 and 401 represent the radiation patterns generated by applying the patch antenna units Ant_1 and Ant_4, respectively. When the signal feed phase of the patch antenna unit Ant_1 and the signal feed phase of the patch antenna unit Ant_4 differ by 180 degrees, a curve 403 represents the radiation pattern generated by simultaneously applying the patch antenna units Ant_1 and Ant_4. The curve 403 is a symmetrical pattern, making it more ideal for estimating the phase error using the patch antenna units Ant_1 and Ant_4. Symmetrical patterns provide a more uniform and simplified field environment, enabling more accurate and efficient calculation of phase errors.

In some embodiments, the second phase error between the third patch antenna unit and the fourth patch antenna unit may be determined. The third patch antenna unit and the fourth patch antenna unit are located on the same side of the antenna matrix. For example, the third patch antenna unit and the fourth patch antenna unit may correspond to the patch antenna unit Ant_3 and the patch antenna unit Ant_2, respectively, as shown in FIG. 3A. The method for determining the second phase error between the third patch antenna unit and the fourth patch antenna unit is similar to the method for determining the first phase error between the first patch antenna unit and the second patch antenna unit as described in steps S402 to S410, and will not be redundantly detailed here.

In some embodiments, the third phase error between the first patch antenna unit and the third patch antenna unit may be determined. The first patch antenna unit and the third patch antenna unit are located at the diagonal positions of the antenna matrix. For example, the first patch antenna unit and the third patch antenna unit may correspond to the patch antenna unit Ant_1 and the patch antenna unit Ant_3, respectively, as shown in FIG. 3A. The method for determining the third phase error between the first patch antenna unit and the third patch antenna unit is similar to the method for determining the first phase error between the first patch antenna unit and the second patch antenna unit as described in steps S402 to S410, and will not be redundantly detailed here.

Thus, after determining the phase errors among the patch antenna units, in some embodiments, phase compensation for the antenna array may be performed based on the first phase error between the first patch antenna unit and the second patch antenna unit, the second phase error between the third patch antenna unit and the fourth patch antenna unit, and the third phase error between the first patch antenna unit and the third patch antenna unit. Referring to FIG. 3A, phase compensation amounts for all the patch antenna units Ant_1 to Ant_4 may be determined based on the first phase error between the patch antenna unit Ant_1 and the patch antenna unit Ant_4, the second phase error between the patch antenna unit Ant_2 and the patch antenna unit Ant_3, and the third phase error between the patch antenna unit Ant_1 and the patch antenna unit Ant_3.

In summary, in the embodiments of the disclosure, the integrated antenna device may be assembled as a large antenna array, allowing certain parts of the large antenna array to be independently replaced or repaired, thereby reducing maintenance costs. Furthermore, the phase errors among the patch antenna units in the integrated antenna device may be obtained through simple calculations, significantly reducing the difficulty of phase compensation and improving antenna performance.

Although the disclosure has been disclosed above with embodiments, they are not intended to limit the disclosure. Any person having ordinary knowledge in the technical field may make slight modifications and refinements without departing from the spirit and scope of the disclosure. Therefore, the protection scope of the disclosure shall be defined by the appended claims.

What is claimed is:

1. An integrated antenna device, comprising:
an antenna array formed by a plurality of patch antenna units and disposed on a first surface of a substrate, wherein the plurality of patch antenna units are symmetrically arranged around an array center of the antenna array, and each of the plurality of patch antenna units comprises a first feed point and a second feed point; and
a beamforming integrated circuit, disposed on a second surface of the substrate opposite to the first surface, and connected to the first feed point and the second feed point of the each of the plurality of patch antenna units,
wherein the each of the plurality of patch antenna units comprises a first linear radiation portion having a first polarization direction and a second linear radiation portion having a second polarization direction, the first linear radiation portion comprises the first feed point, and the second linear radiation portion comprises the second feed point, an extending direction of the first linear radiation portion being perpendicular to an extending direction of the second linear radiation portion,
wherein the first feed point and the second feed point of the each of the plurality of patch antenna units are disposed outside the each of the plurality of patch antenna units relative to the array center of the antenna array, and the beamforming integrated circuit overlaps a central area of the antenna array.

2. The integrated antenna device according to claim 1, wherein the plurality of patch antenna units are arranged in a 2×2 matrix, and a distance between two adjacent ones of the plurality of patch antenna units is a half of a wavelength, corresponding to a center frequency of an operational frequency band of the antenna array, in an operational environment.

3. The integrated antenna device according to claim 1, wherein the each of the plurality of patch antenna units has the first polarization direction and the second polarization direction orthogonal to the first polarization direction, the first feed point being configured to enable the each of the plurality of patch antenna units to transmit and receive according to the first polarization direction, and the second feed point being configured to enable the each of the plurality of patch antenna units to transmit and receive according to the second polarization direction.

4. The integrated antenna device according to claim 1, wherein the each of the plurality of patch antenna units further comprises a plurality of pattern adjustment portions, and the plurality of pattern adjustment portions are of a four-leaf clover-shaped structure.

5. The integrated antenna device according to claim 1, wherein a plurality of radio frequency signal transmission paths between the plurality of first feed points of the plurality of patch antenna units and the beamforming integrated circuit are substantially equal in length, and a plurality of radio frequency signal transmission paths between the plurality of second feed points of the plurality of patch antenna units and the beamforming integrated circuit are substantially equal in length.

6. The integrated antenna device according to claim 5, wherein a center of the beamforming integrated circuit projects onto the array center of the antenna array along a direction perpendicular to a surface of the substrate.

7. The integrated antenna device according to claim 1, further comprising a connection portion, configured to receive an external power, be connected to the beamforming integrated circuit via a bus interface, and transmit a radio frequency signal with the beamforming integrated circuit.

8. The integrated antenna device according to claim 7, wherein the connection portion comprises a plurality of copper pillars disposed on the substrate.

9. A phase calibration method for an integrated antenna device (100), wherein an antenna array of the integrated antenna device comprises a first patch antenna unit, a second patch antenna unit, a third patch antenna unit, and a fourth patch antenna unit arranged in a 2×2 matrix, the phase calibration method comprising:
receiving a first radio frequency signal from a far field through the first patch antenna unit and the second patch antenna unit;
mixing a plurality of radio frequency signals respectively generated in response to the first radio frequency signal by the first patch antenna unit and the second patch antenna unit to produce a first mixed signal;
transmitting a second radio frequency signal to the far field through the first patch antenna unit and the second patch antenna unit;
mixing a plurality of radio frequency signals generated in response to the second radio frequency signal by the first patch antenna unit and the second patch antenna unit to produce a second mixed signal; and
determining a first phase error between the first patch antenna unit and the second patch antenna unit according to an amplitude ratio of the first mixed signal and the second mixed signal.

10. The phase calibration method for the integrated antenna device according to claim 9, wherein when receiving the first radio frequency signal from the far field, a signal feed phase of the first patch antenna unit and a signal feed phase of the second patch antenna unit are configured to differ by 180 degrees, so as to produce the first mixed signal corresponding to a destructive interference.

11. The phase calibration method for the integrated antenna device according to claim 9, wherein when transmitting the second radio frequency signal to the far field, a signal feed phase of the first patch antenna unit and a signal feed phase of the second patch antenna unit are configured to differ by 0 degrees, so as to produce the second mixed signal corresponding to a constructive interference.

12. The phase calibration method for the integrated antenna device according to claim 9, further comprising:
determining a second phase error between the third patch antenna unit and the fourth patch antenna unit; and
determining a third phase error between the first patch antenna unit and the third patch antenna unit.

13. The phase calibration method for the integrated antenna device according to claim 12, further comprising:
performing a phase compensation for the antenna array according to the first phase error, the second phase error, and the third phase error.

14. The phase calibration method for the integrated antenna device according to claim 9, wherein the first radio frequency signal comprises a first polarized signal having a first polarization direction or a second polarized signal having a second polarization direction.

15. The phase calibration method for the integrated antenna device according to claim 9, wherein the first phase error is twice the amplitude ratio of the first mixed signal and the second mixed signal.
